(19) United States
(12) Patent Application Publication
(10) Pub. No.: US 2013/0107157 A1
(43) Pub. Date: May 2, 2013

(54) LIQUID CRYSTAL DISPLAY

(71) Applicants: Ruilian Yang, Shenzhen (CN); Yu-Chun Hsiao, Shenzhen (CN)

(72) Inventors: Ruilian Yang, Shenzhen (CN); Yu-Chun Hsiao, Shenzhen (CN)

(73) Assignee: SHENZHEN CHINA STAR OPTOELECTRONICS TECHNOLOGY CO., LTD., Shenzhen (CN)

(21) Appl. No.: 13/378,428

(22) PCT Filed: Nov. 8, 2011
(86) PCT No.: PCT/CN2011/081926

§ 371 Date: Dec. 15, 2011

(30) Foreign Application Priority Data
Nov. 1, 2011 (CN) 201120426367.1

(51) Int. Cl. G02F 1/13357

(52) U.S. Cl. 349/58

(57) ABSTRACT

A liquid crystal display includes a front frame, a liquid crystal panel, and a backlight module. The backlight module includes a back plate, a heat sink, a light emitting diode (LED) light source, a light guide plate, and a first heat insulating supporting member. The heat sink is disposed on the back plate, and includes a bottom plate and a first side plate perpendicular to the bottom plate. The LED light source is disposed on one inner surface of the first side plate facing the bottom plate. The light guide plate is disposed between the bottom plate and the liquid crystal panel, and includes a light incident side corresponding to the LED light source. The first heat insulating supporting member is disposed on the light guide plate for supporting the liquid crystal panel and can cooperate with the front frame to clamp the liquid crystal panel.

### BACKGROUND

1. Technical Field

The present disclosure relates to liquid crystal displaying technologies, and particularly to a liquid crystal display.

2. Description of Related Art

Nowadays, liquid crystal displays (LCDs) are commonly used in various kinds of electronic devices such as mobile phones, personal digital assistances, digital cameras, computer screens, and notebook computers and the like. An LCD often includes a backlight module and a liquid crystal panel. With the development of technologies and higher requirements from users, LCDs with shorter rims have become prevailing. However, with the backlight module, the rims of the liquid crystal display cannot be shortened enough to meet the requirements from users.

Referring to FIG. 1, the LCD includes a front frame, a backlight module, and a liquid crystal panel disposed adjacent to the backlight module. The backlight module includes an L shaped back plate 3, a plastic frame 2, an L shaped heat sink 4 disposed on the back plate 3, a light emitting diode (LED) light source 5 disposed on the heat sink 4, a reflective plate 6, and a light guide plate 7 with a light incident side thereof corresponding to the LED light source 5. The liquid crystal panel is sandwiched between the front frame 1 and the plastic frame 2. With the above components, a length of a portion of the backlight module adjacent to the LED light source becomes so large that the rims of the LCD cannot be shortened.

Therefore, there is room for improvement.

### SUMMARY

The present disclosure provides a liquid crystal display. The liquid crystal display includes a front frame, a liquid crystal panel, and a backlight module. The backlight module includes a back plate, a heat sink, a light emitting diode (LED) light source, a light guide plate, and a first heat insulating supporting member. The back plate is made of metal and defines at least one fixing hole. The heat sink is disposed on the back plate through the at least one fixing hole, and includes a bottom plate and a first side plate perpendicular to the bottom plate. The LED light source is disposed on one inner surface of the first side plate facing the bottom plate. The light guide plate is disposed between the bottom plate and the liquid crystal panel, and includes a light incident side corresponding to the LED light source. The first heat insulating supporting member is disposed on the light guide plate for supporting the liquid crystal panel and is capable of cooperating with the front frame to clamp the liquid crystal panel.

Preferably, the front frame includes a top plate and a second side plate perpendicular to the top plate, the second side plate is parallel to the first side plate and contacts with the first side plate, the top plate cooperates with the first supporting member to clamp the liquid crystal panel, and the back plate is located under the bottom plate and is fixed to the bottom plate through the at least one fixing hole.

Preferably, the LED light source includes a printed circuit board and a number of LEDs disposed on the printed circuit board, one side portion of the printed circuit board opposite to the LEDs contacts the inner surface of the first side plate, a bottom surface of the first supporting member contacts a top surface of the light guide plate and extends from the top surface of the light guide plate to partly suspend above the LED light source to partly cover the LEDs.

Preferably, the backlight module further includes an optical film sandwiched between the liquid crystal panel and the light guide plate, the first supporting member includes a third side plate parallel to the light guide plate and a forth side plate perpendicular to the third side plate, the third side plate supports the liquid crystal panel, the forth side plate contacts the top surface of the light guide plate, and the first supporting member is capable of cooperating with the top surface of the light guide plate to define a slot for receiving the optical film.

Preferably, the second side plate is fixed to the first side plate, and a top surface of the first side plate contacts a bottom surface of the top plate of the front frame.

Preferably, the backlight module further includes a second heat insulating supporting member, one end of the inner surface of the first side plate away from the bottom plate is recessed to define a recess for receiving the second supporting member, the recess is surrounded by a first side wall substantially paralleled to the inner surface of the first side plate and a second side wall substantially coplanar with a top portion of the printed circuit board.

Preferably, a protrusion protrudes from the bottom plate for supporting the light guide plate, and the protrusion is bonded to the bottom plate.

Preferably, the protrusion is made of heat insulating material.

Preferably, a protrusion protrudes from the bottom plate for supporting the light guide plate, and the protrusion is integrally formed with the bottom plate.

Preferably, the backlight module further includes a reflective plate sandwiched between the bottom plate and the light guide plate.

Preferably, the liquid crystal display further includes a buffering member disposed between the top plate and the liquid crystal panel.

The present disclosure further provides another liquid crystal display. The liquid crystal display includes a front frame, a liquid crystal panel, and a backlight module. The backlight module includes a back plate, a heat sink, a LED light source, a light guide plate, and a first heat insulating supporting member. The heat sink is disposed on the back plate through the at least one fixing hole, and includes a bottom plate and a first side plate perpendicular to the bottom plate. The LED light source is disposed on one inner surface of the first side plate facing the bottom plate. The light guide plate is disposed between the bottom plate and the liquid crystal panel, and includes a light incident side corresponding to the LED light source. The first heat insulating supporting member is disposed on the light guide plate for supporting the liquid crystal panel and is capable of cooperating with the front frame to clamp the liquid crystal panel.

Preferably, the front frame includes a top plate and a second side plate perpendicular to the top plate, the second side plate is parallel to the first side plate and contacts with the first side plate, the top plate cooperates with the first supporting member to clamp the liquid crystal panel, and the back plate is located under the bottom plate and is fixed to the bottom plate.

Preferably, the LED light source includes a printed circuit board and a number of LEDs disposed on the printed circuit board, one side portion of the printed circuit board opposite to the LEDs contacts the inner surface of the first side plate, a bottom surface of the first supporting member contacts a top surface of the light guide plate and extends from the top surface of the light guide plate to partly suspend above the LED light source to partly cover the LEDs.

Preferably, the backlight module further includes an optical film sandwiched between the liquid crystal panel and the light guide plate, the first supporting member includes a third side plate parallel to the light guide plate and a forth side plate perpendicular to the third side plate, the third side plate supports the liquid crystal panel, the forth side plate contacts the top surface of the light guide plate, and the first supporting member is capable of cooperating with the top surface of the light guide plate to define a slot for receiving the optical film.

Preferably, the second side plate is fixed to the first side plate, and a top surface of the first side plate contacts a bottom surface of the top plate of the front frame.

Preferably, the backlight module further includes a second heat insulating supporting member, one end of the inner surface of the first side plate away from the bottom plate is recessed to define a recess for receiving the second supporting member, the recess is surrounded by a first side wall substantially paralleled to the inner surface of the first side plate and a second side wall substantially coplanar with a top portion of the printed circuit board.

Preferably, a protrusion protrudes from the bottom plate for supporting the light guide plate, and the protrusion is integrally formed with the bottom plate.

Preferably, the backlight module further includes a reflective plate sandwiched between the bottom plate and the light guide plate.

Preferably, the liquid crystal display further includes a buffering member disposed between the top plate and the liquid crystal panel.

In the present disclosure, a plastic frame and a part of the back plate of the conventional backlight module can be omitted and the liquid crystal panel can be fixed on the heat sink directly. Thus, a thickness of the backlight module along a horizontal direction perpendicular to the first side plate can be reduced to shorten a rim of the LCD display. Also, the light mixing distance of the LED light source can be increased to improve the display effect of the LCD display. At the same time, the first supporting member is capable of partly cover the LED light source to prevent the light emitted from the LED light source leaking out, and further to improve the display effect of the LCD display.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a partially schematic view of a conventional liquid crystal display (LCD).

FIG. 2 is a partially schematic view of an LCD in accordance with an embodiment of the present disclosure.

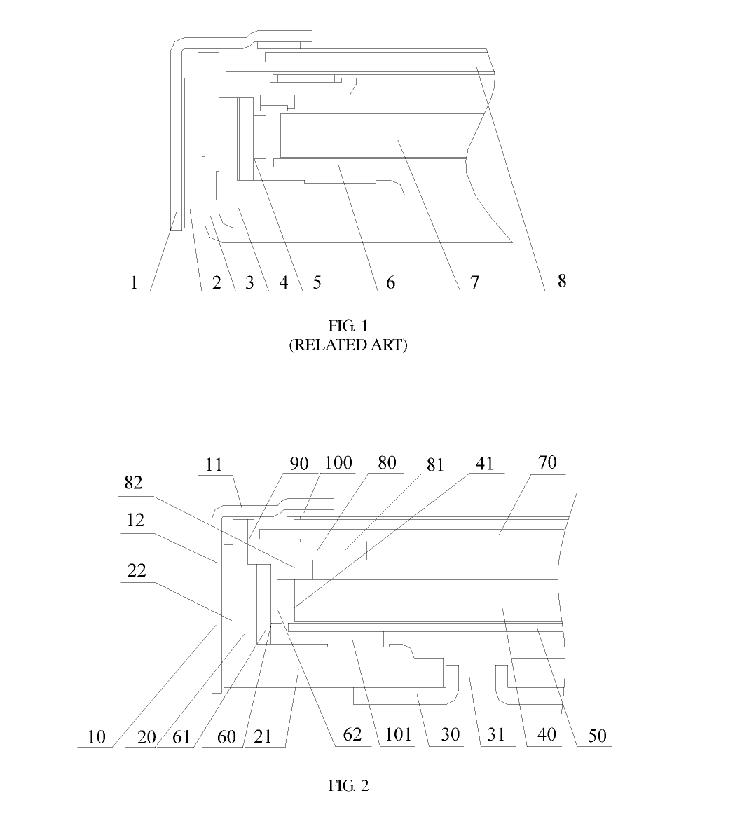

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

Referring to FIG. 2, a liquid crystal display (LCD) includes a front frame 10, a liquid crystal panel 70, a first heat insulating supporting member 80, a second heat insulating supporting member 90, and a backlight module. The backlight module includes a back plate 30, an L shaped heat sink 20 disposed on the back plate 30, a reflective plate 50, a light guide plate 40, and a light emitting diode (LED) light source 60.

The heat sink 20 includes a bottom plate 21 and a first side plate 22 perpendicularly extending from the bottom plate 21. A protrusion 101 protrudes from a top surface of the bottom plate 21. In the embodiment, the protrusion 101 is made of heat insulating material such as elastic or rubber or the like and is bonded to the top surface of the bottom plate 21. Thus, a heat dissipating space can be defined to allow the heat of the backlight module to be dissipated effectively. In other embodiments, the protrusion 101 can be integrally formed with the bottom plate 21. The first side plate 22 includes an inner surface facing the bottom plate 21. One end of the inner surface of the first side plate 22 away from the bottom plate 21 is recessed to define a recess. The recess is surrounded by a first side wall substantially paralleled to the inner surface of the first side plate 22 and a second side wall substantially perpendicular to the first side wall.

The back plate 30 is located under the bottom plate 21 and is fixed to the bottom plate 21 by attaching members such as screws. In the embodiment, the back plate 30 is made of metal. At least one fixing hole 31 is defined in the back plate 30 for passing through at least one screw to connect the bottom plate 21 with the back plate 30.

It is noted that in some embodiments, a width of the back plate 30 can be equal to or smaller than that of the bottom plate 21 to adjust a contacting area between the back plate 30 and the bottom plate 21.

The reflective plate 50 is located above the bottom plate 21 and is supported by the protrusion 101. The LED light source 60 is disposed on the inner surface of the first side plate 22. The LED light source 60 includes a printed circuit board (PCB) 61 and a number of LEDs 62. The PCB 61 is disposed on the inner surface of the first side plate 22 and is located under the recess. The PCB 61 includes a top portion being substantially coplanar with the second side wall of the recess and a side portion opposite and substantially parallel to the inner surface of the first side plate. The LEDs 62 are disposed on the side portion of the PCB 61. The light guide plate 40 is disposed above the reflective plate 50 and includes a light incident side 41 corresponding to the LED light source 60.

The front frame 10 includes a top plate 11 and a second side plate 12 perpendicular to the top plate 11. The top plate 11 is located above the heat sink 20. The second side plate 12 is parallel to the first side plate 22 and is connected to the first side plate 22 via screws.

The liquid crystal panel 70 is sandwiched between the light guide plate 40 and the top plate 11 of the front frame 10.

The first supporting member 80 is disposed between the light guide plate 40 and the liquid crystal panel 70 for supporting the liquid crystal panel 70. The first supporting member 80 further cooperates with the top plate 11 of the front frame 11 to clamp the liquid crystal panel 70. The first supporting member 80 is a substantially L shaped piece made of plastic or rubber or the like. In the embodiment, the first supporting member 80 is made of rubber, and includes a third side plate 81 and a forth side plate 82. The third side plate 81 contacts the liquid crystal panel 70 and is parallel to the liquid crystal panel 70. The forth side plate 82 perpendicularly extends from the third side plate 81 to partly contact a top surface of the light guide plate 40 and partly suspend above the LEDs 62 of the LED light source 60.

After the first supporting member 80 is disposed between the light guide plate 40 and the liquid crystal panel 70, the first supporting member 80 is capable of cooperating with the top surface of the light guide plate 40 to define a slot for receiving an optical film of the LCD display. Also, since the forth side plate 82 of the first supporting member 80 partly extends above the LED light source 60, thus, the first supporting member 80 is capable of partly covering the LED light source 60 to prevent the light emitted from the LED light source 60 from leaking out. Additionally, the first supporting member 80 is capable of cooperating with the first side plate 22 and the top plate 11 to fix the liquid crystal panel 70 prevent the liquid crystal panel 70 from moving along a direction parallel to the light guide plate 40. In some embodiments, the LCD display may include two of the LED light sources 60 respectively located at two opposite sides of the light guide plate 40. In this state, conventional plastic frame fixing structure may be used for cooperating with the first supporting member 80 to stably fix the liquid crystal panel.

The second supporting member 90 is configured for preventing the heat generated on the heat sink 20 from being conducted to the liquid crystal panel 70. The second supporting member 90 is received in the recess defined in the inner surface of the first side plate 22 and is located above the PCB 61 of the LED light source 60. The second supporting member 90 contacts the first side wall of the recess. The second supporting member 90 is substantially L shaped and made of heat insulating material such as plastic or rubber or the like. In the embodiment, the second supporting member 90 is made of rubber.

With the second supporting member 90, the heat of the heat sink 20 cannot be conducted to the liquid crystal panel 70. Also, since the second supporting member 90 is received in the recess, the second supporting member 90 can act as a buffering member to protect the liquid crystal panel 70 from being damaged when the liquid crystal panel is moved towards the first side plate 22.

In assembly, the back plate 30 is fixed to the heat sink 20 via strews firstly. After that, the PCB 61 with the LEDs 62 mounted thereon is fixed to the inner surface of the first side plate 22 of the heat sink 20. The reflective plate 50 and the light guide plate 40 are fixed to the bottom plate 21 in order. After that, the first supporting member 80 is placed above the light guide plate 40 for supporting the liquid crystal panel 70. The front frame 10 then is fixed to the heat sink 20, with the top plate 11 thereof contacting a top surface of the first side plate 22 and the second side plate 12 thereof contacting one side of the first side plate 22 opposite to the LED light source 60. The second side plate 12 further is fixed to the first side plate 22 via screws. Thus, the first supporting member 80 and the top plate 11 of the front frame 11 and the first side plate 22 are capable of cooperating with each other to clamp the liquid crystal panel 70.

In the present disclosure, a plastic frame and a part of the back plate 30 of the conventional backlight module can be omitted and the liquid crystal panel 70 can be fixed on the heat sink 20 directly. Thus, a thickness of the backlight module along a horizontal direction perpendicular to the first side plate 22 can be reduced so as to shorten a rim of the LCD display. Also, the light mixing distance of the LED light source 60 can be increased to improve the display effect of the LCD display. At the same time, the first supporting member is capable of partly covering the LED light source 60 to prevent the light emitted from the LED light source from leaking out, and further improving the display effect of the LCD display. The second supporting member 90 is capable of preventing the heat generated by the heat sink 20 from being connected to the liquid crystal panel 70 and thus also improving the display effect of the liquid crystal panel 70. Also, the second supporting member 90 can cooperate with the heat sink to prevent the liquid crystal panel 70 from being damaged.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A liquid crystal display, comprising:
a front frame;
a liquid crystal panel; and
a backlight module, comprising:
a back plate made of metal and defining at least one fixing hole;
a heat sink disposed on the back plate through the at least one fixing hole, the heat sink comprising a bottom plate and a first side plate perpendicular to the bottom plate;
a LED light source disposed on an inner surface of the first side plate facing the bottom plate;
a light guide plate disposed between the bottom plate and the liquid crystal panel, the light guide plate comprising a light incident side corresponding to the LED light source; and
a first heat insulating supporting member disposed on the light guide plate for supporting the liquid crystal panel, the first supporting member being capable of cooperating with the front frame to clamp the liquid crystal panel.

2. The liquid crystal display as claimed in claim 1, wherein the front frame comprises a top plate and a second side plate perpendicular to the top plate, the second side plate is parallel to the first side plate and contacts with the first side plate, the top plate cooperates with the first supporting member to clamp the liquid crystal panel, and the back plate is located under the bottom plate and is fixed to the bottom plate through the at least one fixing hole.

3. The liquid crystal display as claimed in claim 2, wherein the LED light source comprises a printed circuit board and a number of LEDs disposed on the printed circuit board, one side portion of the printed circuit board opposite to the LEDs contacts the inner surface of the first side plate, a bottom surface of the first supporting member contacts a top surface of the light guide plate and extends from the top surface of the light guide plate to partly suspend above the LED light source to partly cover the LEDs.

4. The liquid crystal display as claimed in claim 3, wherein the backlight module further comprises an optical film sandwiched between the liquid crystal panel and the light guide plate, the first supporting member comprises a third side plate parallel to the light guide plate and a forth side plate perpendicular to the third side plate, the third side plate supports the liquid crystal panel, the forth side plate contacts the top surface of the light guide plate, and the first supporting member is capable of cooperating with the top surface of the light guide plate to define a slot for receiving the optical film.

5. The liquid crystal display as claimed in claim 3, wherein the second side plate is fixed to the first side plate, and a top surface of the first side plate contacts a bottom surface of the top plate of the front frame.

6. The liquid crystal display as claimed in claim 5, wherein the backlight module further comprises a second heat insulating supporting member, one end of the inner surface of the first side plate away from the bottom plate is recessed to define a recess for receiving the second supporting member, the recess is surrounded by a first side wall substantially paralleled to the inner surface of the first side plate and a second side wall substantially coplanar with a top portion of the printed circuit board.

7. The liquid crystal display as claimed in claim 6, wherein a protrusion protrudes from the bottom plate for supporting the light guide plate, and the protrusion is bonded to the bottom plate.

8. The liquid crystal display as claimed in claim 7, wherein the protrusion is made of heat insulating material.

9. The liquid crystal display as claimed in claim 6, wherein a protrusion protrudes from the bottom plate for supporting the light guide plate, and the protrusion is integrally formed with the bottom plate.

10. The liquid crystal display as claimed in claim 7, wherein the backlight module further comprises a reflective plate sandwiched between the bottom plate and the light guide plate.

11. The liquid crystal display as claimed in claim 2 further comprising a buffering member disposed between the top plate and the liquid crystal panel.

12. A liquid crystal display, comprising:
a front frame;
a liquid crystal panel; and
a backlight module, comprising:
a back plate;
a heat sink disposed on the back plate through the at least one fixing hole, the heat sink comprising a bottom plate and a first side plate perpendicular to the bottom plate;
a LED light source disposed on an inner surface of the first side plate facing the bottom plate;
a light guide plate disposed between the bottom plate and the liquid crystal panel, the light guide plate comprising a light incident side corresponding to the LED light source; and
a first heat insulating supporting member disposed on the light guide plate for supporting the liquid crystal panel, the first supporting member being capable of cooperating with the front frame to clamp the liquid crystal panel.

13. The liquid crystal display as claimed in claim 12, wherein the front frame comprises a top plate and a second side plate perpendicular to the top plate, the second side plate is parallel to the first side plate and contacts with the first side plate, the top plate cooperates with the first supporting member to clamp the liquid crystal panel, and the back plate is located under the bottom plate and is fixed to the bottom plate.

14. The liquid crystal display as claimed in claim 13, wherein the LED light source comprises a printed circuit board and a number of LEDs disposed on the printed circuit board, one side portion of the printed circuit board opposite to the LEDs contacts the inner surface of the first side plate, a bottom surface of the first supporting member contacts a top surface of the light guide plate and extends from the top surface of the light guide plate to partly suspend above the LED light source to partly cover the LEDs.

15. The liquid crystal display as claimed in claim 14, wherein the backlight module further comprises an optical film sandwiched between the liquid crystal panel and the light guide plate, the first supporting member comprises a third side plate parallel to the light guide plate and a forth side plate perpendicular to the third side plate, the third side plate supports the liquid crystal panel, the forth side plate contacts the top surface of the light guide plate, and the first supporting member is capable of cooperating with the top surface of the light guide plate to define a slot for receiving the optical film.

16. The liquid crystal display as claimed in claim 14, wherein the second side plate is fixed to the first side plate, and a top surface of the first side plate contacts a bottom surface of the top plate of the front frame.

17. The liquid crystal display as claimed in claim 16, wherein the backlight module further comprises a second heat insulating supporting member, one end of the inner surface of the first side plate away from the bottom plate is recessed to define a recess for receiving the second supporting member, the recess is surrounded by a first side wall substantially paralleled to the inner surface of the first side plate and a second side wall substantially coplanar with a top portion of the printed circuit board.

18. The liquid crystal display as claimed in claim 17, wherein a protrusion protrudes from the bottom plate for supporting the light guide plate, and the protrusion is integrally formed with the bottom plate.

19. The liquid crystal display as claimed in claim 18, wherein the backlight module further comprises a reflective plate sandwiched between the bottom plate and the light guide plate.

20. The liquid crystal display as claimed in claim 13 further comprising a buffering member disposed between the top plate and the liquid crystal panel.
